(19) United States
(12) Patent Application Publication
(10) Pub. No.: US 2008/0138514 A1
(43) Pub. Date: Jun. 12, 2008

(54) PREPARATION METHOD OF MULTI-SHELL NANOCRYSTALS

(75) Inventors: Eun Joo JANG, Yeongtong-gu (KR); Shin Ae JUN, Seongnam-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 11/831,437

(22) Filed: Jul. 31, 2007

(30) Foreign Application Priority Data
Dec. 1, 2005 (KR) 10-2005-116322

(51) Int. Cl. B01J 13/02

(52) U.S. Cl. 427/213.3

(57) ABSTRACT

Disclosed is a preparation method of multi-shell nanocrystals in one pot. In an embodiment, a core is formed from a precursors in the presence of solvent and then, without a core separation step, two or more kinds of precursors are added sequentially to dispose a shell on the surface of the core. The method provides a scaleable process suitable for mass production of high quality multi-shell nanocrystals, having diverse bandgaps and high luminescence efficiency. The method does not use a core separation procedure after core synthesis.

This application claims priority to Korean Patent Application No. 10-2005-116322, filed on Dec. 1, 2005, and all the benefits accruing therefrom under 35 U.S.C. § 119, the content of which is incorporated herein by reference in its entirety.

### BACKGROUND OF THE INVENTION

1. Field of the Invention

Embodiments of the invention relate to methods for preparation of multi-shell nanocrystals, and, in particular, to one pot methods for preparation of multi-shell nanocrystals. Nanocrystals formed according to the embodiments have a core prepared from a precursor in the presence of a solvent. Subsequently, without a core separation step, a distinct precursor is used sequentially to form a shell on the surface of the core.

2. Description of the Related Art

A nanocrystal is a material with dimensions of several nanometers comprised of several hundreds to several thousands of atoms. Nanocrystals can exhibit electrical, magnetic, optical, chemical and mechanical properties different from the intrinsic properties of a bulk material with the same composition. The properties of nanocrystals can be adjusted by controlling the physical size of nanocrystals.

Methods for synthesizing nanocrystals include vapor deposition processes such as metal organic chemical vapor deposition (MOCVD) or molecular beam epitaxy (MBE). Alternatively, nanocrystals can be prepared using a wet chemistry technique in which a precursor material is added to an organic solvent to grow a nanocrystal. Specifically, in the wet chemistry technique, a surfactant is coordinated on the surface of a nanocrystal to control crystal growth during reaction. Therefore, the wet chemistry technique can be used to prepare nanocrystals with uniform size and shape more easily and at lower cost than vapor deposition processes such as MOCVD or MBE.

For example, U.S. Pat. No. 6,225,198 to Alivisatos et al. discloses a technique for synthesizing shaped nanocrystals by contacting solutions with Group II-VI metal precursors with a liquid media, the liquid media comprising a binary surfactant mixture, and the resulting mixture maintained at a crystal growth temperature. U.S. Pat. No. 6,306,736, also to Alivisatos et al., provides a process for synthesizing nanocrystals by the same preparation procedure as is disclosed in U.S. Pat. No. 6,225,198, but using compounds with Group III-V metals.

U.S. Pat. No. 6,322,901 to Bawendi et al. discloses Group II-VI and III-V semiconductor nanocrystals with core-shell structures. The structures disclosed by Bawendi et al. featuring high luminescence efficiency were obtained by forming a semiconductor layer with a bandgap greater than the core on the surface of a core nanocrystal. U.S. Pat. No. 6,207,229, also to Bawendi et al., teaches a method for coating nanocrystals to provide a core-shell structure. Bawendi reports that the nanocrystals with core-shell structures exhibit luminescence efficiency of 30 to 50%.

However, as illustrated in FIG. 1, disclosed wet chemistry methods for preparing core-shell nanocrystals have a core separation step between the synthesis of a core and the formation of shells, so the preparation procedure is rather complicated and costly. Moreover, because the accurate concentration and content of the synthesized core component are unknown in methods that employ a core separation step, it is difficult to mass produce nanocrystals by such methods.

### BRIEF SUMMARY OF THE INVENTION

Disclosed herein is a method for the preparation of multi-shell nanocrystals suitable for mass-production of high quality multi-shell nanocrystals with high reproducibility. The disclosed method provides a simple and economic one-pot procedure that eliminates the need for a separation step after synthesis of nanocrystal cores.

In accordance with the embodiments, provided is a method for preparing multi-shell nanocrystals in one pot, comprising: synthesizing a core with a precursor in the presence of solvent; and adding sequentially, without separating the core, a metal precursor to form a shell on the surface of the core.

### BRIEF DESCRIPTION OF THE DRAWINGS

The above and other features and advantages of the embodiments will be more clearly understood from the following detailed description taken in conjunction with the accompanying drawings, in which:

FIG. 1 is a schematic diagram illustrating a method for synthesizing a nanocrystal of the prior art;

FIG. 2 is a schematic diagram illustrating an exemplary method for synthesizing a nanocrystal according to one embodiment;

FIG. 3 is a photoluminescence plot showing the emission wavelength of an exemplary nanocrystal prepared according to Example 1;

FIGS. 4a-4c show TEM images of exemplary nanocrystals obtained at each reaction stage according to an embodiment; and,

FIG. 5 is a photoluminescence plot showing the emission wavelength of an exemplary nanocrystal prepared according to Example 2.

### DETAILED DESCRIPTION OF THE INVENTION

Hereinafter, embodiments will be explained in more detail with reference to the accompanying drawings.

It will be understood that when an element is referred to as being “on” another element, or “between” or “interposed between” other elements, it can be directly in contact with the other element, or intervening elements may be present therebetween. In contrast, when an element is referred to as being “disposed on” or “formed on” another element, the elements are understood to be in at least partial contact with each other, unless otherwise specified.

The terminology used herein is for the purpose of describing particular embodiments only and is not intended to be limiting of the invention. As used herein, the singular forms “a”, “an” and “the” are intended to include the plural forms as well, unless the context clearly indicates otherwise. The use of the terms “first”, “second”, and the like do not imply any particular order but are included to identify individual elements. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “Group” refers to a vertical column of elements in the periodic table of the elements. The term “Group II metal precursor” as used herein means a compound comprised of zinc, cadmium or mercury (Zn, Cd or Hg). The term “Group III metal precursor” as used herein means a compound comprised of aluminum, gallium, indium or thallium (Al, Ga, In or Tl). The term “Group IV metal precursor” as used herein means a compound comprised of silicon, germanium, tin or lead (Si, Ge, Sn or Pb). The term “Group V precursor” as used herein means a compound comprised of phosphorous, arsenic, antimony or bismuth (P, As, Sb or Bi). The term “Group VI precursor” as used herein means a compound comprised of sulfur, selenium or tellurium (S, Se or Te).

Illustrated exemplary embodiments disclose methods to prepare multi-shell nanocrystals in one pot. The methods provide a core prepared from a precursor in the presence of a solvent. Subsequently, without a core separation step, precursors are used sequentially to form layers of shell on the surface of the core.

In particular, the preparation of multi-shell nanocrystals according to an embodiment includes: (a) forming a core in a chemical reaction using a precursor; and (b) sequentially adding two or more precursors to the resulting reaction mixture to form a shell on the surface of the core. In the synthesis of the core, a precursor is reacted at a temperature sufficient to decompose the precursor. For example, a precursor may be reacted at about 150 to about 360° C. for about 30 sec to about 12 hours to form a core.

In an embodiment, a shell is disposed directly on the core and is in intimate contact with the core. In an alternative embodiment, the shell can be disposed on another layer that is in intimate contact with the core. In these embodiments, the shell can partially or completely encapsulate the core.

Since the synthesis of a core, and the sequential addition of a precursor for forming a multi-layer shell on the surface of the core, are carried out sequentially in one pot, it is important to control the reaction rate so as not to form a different kind of nucleus. The reaction rate can be controlled by selection of a less reactive precursor, or by selection of the concentration of the precursors, the injection rate, or the reaction temperature. For example, uniform CdSe cores can be prepared by selecting Se injection conditions such as the injection rate, Se concentration, the nature of the carrier solvent, and the temperature.

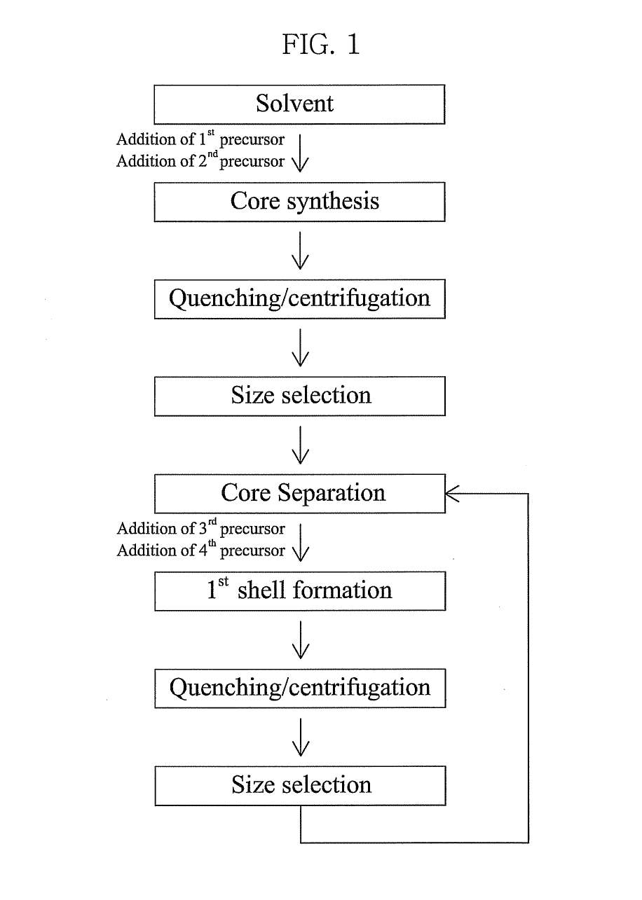

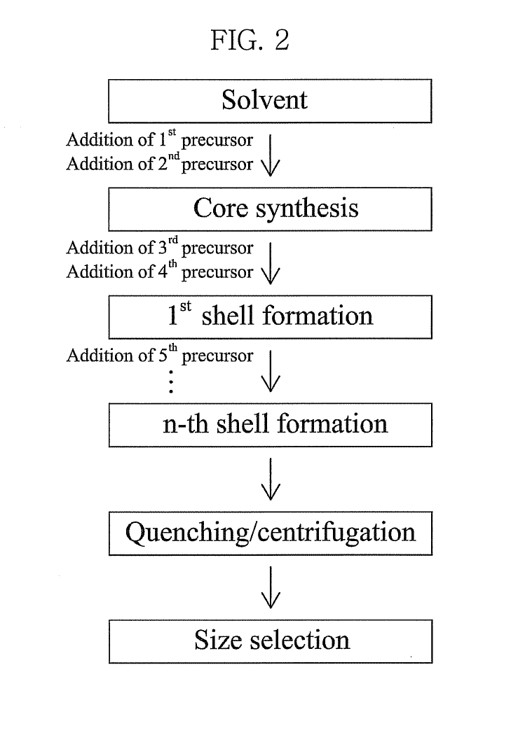

With reference to the FIG. 1 and FIG. 2, a schematic diagram of an exemplary method for preparing multi-shell nanocrystals according to an embodiment, comprises: reacting a Group II, III or IV metal precursor with a Group V or VI precursor, optionally in the presence of a solvent, for a selected time to form a core; sequentially adding, without separating the core, a Group II, III or IV metal precursor, or a Group V or VI precursor to the reaction mixture to dispose a first shell on the surface of the core; sequentially adding a Group II, III or IV metal precursor, or a Group V or VI precursor again to form a second, a third, or n-th shell; and subsequently separating the resulting multi-layer nanocrystal.

Because the synthesis of a core, and the sequential addition of a precursor for producing a multi-layer shell on the surface of the core, is carried out in one pot, the method for preparing nanocrystals according to an embodiment is advantageous in terms of a providing a shortened procedure, wherein the core being formed reacts, at a lower concentration state, with the precursor. Unexpectedly, the luminescence efficiency of core-shell materials prepared according to exemplary embodiments are improved by at least 10%, specifically by 20% to 90%. Without being limited to theory, it is believed that the luminescence efficiency of nanocrystals prepared by the disclosed one pot method is unexpectedly high because the method provides core-shell structures with less oxygen and moisture contamination, in particular contamination associated with the separation step.

In addition, since the preparation method of nanocrystals according to exemplary embodiments makes it possible to control the amount of the synthesized core component, control of the amount, concentration, or addition rate of shell components is enabled. The addition amount, rate, and concentration of shell components can be selected depending on the particular application to provide nanocrystals with the desired properties. Alternatively, the addition amount, rate, and concentration of shell components can be selected to accommodate the scale of the preparation, including mass-production.

In particular, in the preparation of nanocrystals by the method of the exemplary embodiments, the core is formed in a process comprising: (i) mixing a Group II, III or IV metal precursor with a surfactant and a solvent, and heating the reaction mixture at a selected temperature to obtain a metal precursor solution; (ii) dissolving a Group V or VI precursor in a coordinating solvent to obtain a Group V or VI precursor solution; and (iii) adding the Group V or VI precursor solution to the metal precursor solution.

Subsequently, a shell can be disposed by sequentially adding a Group II, III or IV metal precursor solution and a Group V or VI precursor solution.

In the shell formation, the Group II, III or IV metal precursor solution and the Group V or VI precursor solution are obtained by dissolving the precursors in coordinating solvents.

More specifically, examples of metal precursors that can be used are, dimethyl zinc, diethyl zinc, zinc acetate, zinc acetylacetonate, zinc iodide, zinc bromide, zinc chloride, zinc fluoride, zinc carbonate, zinc cyanide, zinc nitrate, zinc oxide, zinc peroxide, zinc perchlorate, zinc sulfate, dimethyl cadmium, diethyl cadmium, cadmium acetate, cadmium acetylacetonate, cadmium iodide, cadmium bromide, cadmium chloride, cadmium fluoride, cadmium carbonate, cadmium nitrate, cadmium oxide, cadmium perchlorate, cadmium phosphide, cadmium sulfate, mercury acetate, mercury iodide, mercury bromide, mercury chloride, mercury fluoride, mercury cyanide, mercury nitrate, mercury oxide, mercury perchlorate, mercury sulfate, lead acetate, lead bromide, lead chloride, lead fluoride, lead oxide, lead perchlorate, lead nitrate, lead sulfate, lead carbonate, tin acetate, tin bisacetylacetonate, tin bromide, tin chloride, tin fluoride, tin oxide, tin sulfate, germanium tetrachloride, germanium oxide, germanium ethoxide, gallium acetylacetonate, gallium chloride, gallium fluoride, gallium oxide, gallium nitrate, gallium sulfate, indium chloride, indium oxide, indium nitrate, indium sulfate, thallium acetate, thallium acetylacetonate, thallium chloride, thallium oxide, thallium ethoxide, thallium nitrate, thallium sulfate, thallium carbonate, or the like, or a combination comprising at least one of the foregoing metal precursors. The metal precursors can be randomly selected and used as long as they contain elements from Group II, III, or IV.

Examples of Group V and VI precursors that can be used are alkyl thiol compounds including, hexane thiol, octane thiol, decane thiol, dodecane thiol, hexadecane thiol, and mercaptopropyl silane, and alkyl phosphine compounds including alkyl phosphine compounds including sulfur-trioctylphosphine (S-TOP), sulfur-tributylphosphine (S-TBP), sulfur-triphenylphosphine (S-TPP), sulfur-trioctylamine (S-TOA), trimethylsilyl sulfur, ammonium sulfide, sodium sulfide, selenium-trioctylphosphine (Se-TOP), selenium-tributylphosphine (Se-TBP), selenium-triphenylphosphine (Se-TPP), tellurium-trioctylphosphine (Te-TOP), tellurium-tributylphosphine (Te-TBP), tellurium-triphenylphosphine (Te-TPP), trimethylsilyl phosphine, triethylphosphine, tributylphosphine, trioctylphosphine, triphenylphosphine, tricyclohexylphosphine, or the like, or a combination comprising at least one of the foregoing Group V and VI precursors. The Group V or VI precursors can be randomly selected and used as long as they contain elements of a Group V or VI.

In an embodiment, the solvent used can be liquid at room temperature and can coordinate the crystal nucleus. Examples of solvents that can be used are C₆₋₂₂ primary alkyl amines, C₆₋₂₂ secondary alkyl amines, and C₆₋₂₂ tertiary alkyl amines, C₆₋₂₂ primary alcohols, C₆₋₂₂ secondary alcohols, C₆₋₂₂ tertiary alcohols, C₆₋₂₂ ketones and esters, C₆₋₂₂ heterocyclic compounds containing nitrogen or sulfur, C₆₋₂₂ alkanes, C₆₋₂₂ alkenes, C₆₋₂₂ alkynes, trioctylamine, trioctylphosphine, trioctylphosphine oxide, or the like, or a combination comprising at least one of the foregoing solvents.

Solvents comprised of 6-18 carbon atoms are selected because they can coordinate and disperse the crystal nucleus and are stable at high reaction temperatures. In addition, the solvent should be able to dissolve the metal precursors or the Group V or VI precursors.

In the method for preparing nanocrystals according to exemplary embodiments, disclosed is the use of the same solvent for the Group II, III or IV metal precursor and for the Group V or VI precursor. Use of the same solvent maintains the same conditions for nanocrystal formation and for successive reaction.

Examples of surfactants that can be used are C₆₋₂₂ alkanes and alkenes having a terminal COOH group; C₆₋₂₂ alkanes and alkenes having a terminal POOH group; C₆₋₂₂ alkanes and alkenes having a terminal SOOH group; and C₆₋₂₂ alkanes and alkenes having a terminal NH₂ group. In particular, the surfactant can be oleic acid, stearic acid, palmitic acid, hexyl phosphonic acid, n-octyl phosphonic acid, tetradecyl phosphonic acid, octadecyl phosphonic acid, n-octyl amine, hexadecylamine, or the like, or a combination comprising at least one of the foregoing surfactants.

A surfactant can be used for preparation of the Group II, III or IV metal precursor or the Group V or VI precursor metal precursor solution that is added at the beginning of core synthesis.

To facilitate crystal growth, and to ensure the stability of the solvent, synthesis of the core and shell structures can be performed a temperature of about 100° C. to about 460° C., preferably at about 120° C. to about 420° C., and more preferably about 150° C. to about 360° C.

Further, reaction rates are controllable. Reactions to form core or shell structures can be carried out for about 5 seconds to about 4 hours, preferably for about 10 seconds to about 3 hours, and more preferably for about 20 seconds to about 2 hours.

The specific reaction temperature and reaction time for forming each of the first, second, third, or n-th shells in the shell formation reaction(s) can be selected to provide the desired nanocrystal properties such as size, bandgap, emission wavelength, or luminescence efficiency, for example.

The diverse properties of nanocrystals, including bandgap, emission wavelength, or luminescence efficiency can be adjusted by controlling the size of nanocrystals and the thickness of the shells. The control of nanocrystal size and shell thickness are achieved by selection of the precursor type, including Group II, III or IV metal precursors or Group V or VI precursors. Also, the addition speed and addition amount or concentration can be selected to control nanocrystal size or shell thickness.

In particular, the metal precursors used in the method for preparing nanocrystals can have a concentration of about 0.0001 M to about 2.0 M, preferably about 0.0001 M to about 1.6 M.

Further, the Group VI or V precursors used in the method for preparing nanocrystals can have a concentration of about 0.0001 M to about 1.5 M, preferably about 0.0001 M to about 1.0 M.

In addition to selection of the reaction temperature and the reaction time, the specific precursor added sequentially in the formation of the core or shell structure, such as the Group II, III or IV metal precursors, or Group V or VI precursors can be selected to control the properties of the resulting nanocrystal. Moreover, parameters such as addition speed and reactant concentration can be selected depending on the properties desired for the resulting nanocrystals. In an embodiment, the addition speed can be controlled with help of a syringe pump.

There is no particular limit to the shape of the multi-shell nanocrystal quantum structure obtained according to the preparation method of the embodiments described above. For instance, a multi-shell nanocrystal structure can be in the shape of a sphere, a rod, a cylinder, a tripod, a tetrapod, a cube, a box, a star or a polygon.

The multi-shell nanocrystal can have a particle size of about 30 nm or below, and such nanoparticles have uniform size distribution.

Furthermore, the emission region of the multi-shell nanocrystal structure broadly expands from 300 nm to 1300 nm, and the luminescence efficiency thereof can increase by up to 10%, preferably by about 20% to up to about 90%.

Exemplary embodiments are next described in more detail. However, these examples are provided for the purpose of illustration only and are not to be construed as limiting the scope of the invention.

### EXAMPLES

### Example 1

### Synthesis of Red Fluorescent CdSe/CdS/ZnS Nanocrystals

Trioctylamine, 200 mL (hereinafter “TOA”), oleic acid, 5.4 g, and cadmium oxide, 0.618 g, were simultaneously added to a round-bottom flask provided with a reflux condenser, and the mixture heated to 300° C. while the mixture was stirred. Separately, selenium (Se) powder was dissolved in trioctylphosphine (hereinafter “TOP”) to obtain a Se-TOP complex solution with a Se concentration of about 0.2 M. To the reaction mixture, 6 ml of the 0.2 M Se-TOP complex solution was quickly added while the reaction mixture was stirred, and the reaction continued for 90 seconds.

Next, into the resulting mixture, was added drop-wise a solution of octanethiol, 2.4 mmol in 2 ml of TOA, and the reaction continued for 30 minutes.

Separately, a solution of zinc acetate was prepared by dissolving 16 mmol of zinc acetate in 4 ml of TOA, and the zinc acetate solution added to the reaction mixture drop-wise. Subsequently, a solution of octanethiol, 20 mmol in 4 ml of TOA, was added drop-wise to the reaction, and stirring continued for 60 minutes.

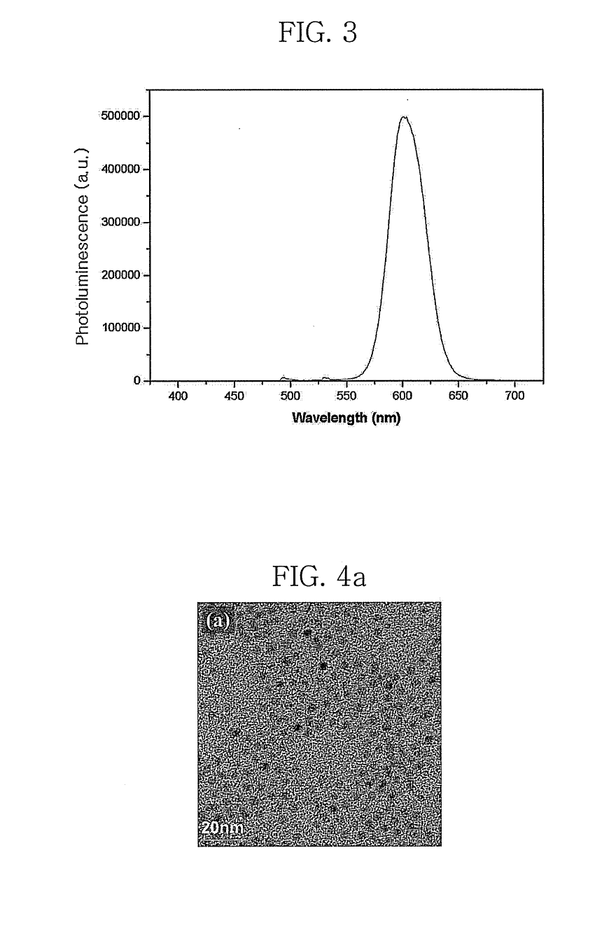

Next, the reaction mixture was cooled to room temperature as rapidly as possible. Ethanol, a non-reactive solvent, was then added to the reaction mixture, and the resulting mixture centrifuged. The precipitate obtained from centrifugation was separated from the supernatant, and the precipitate dispersed in toluene to prepare a solution of CdSe/CdS/ZnS nanocrystals of 3 grams. These nanocrystals exhibited the emission wavelength of 602 nm, and had luminescence efficiency of 76% with respect to Rhodamine 6G. FIG. 3 shows a luminescence spectrum of the nanocrystal prepared according to Example 1.

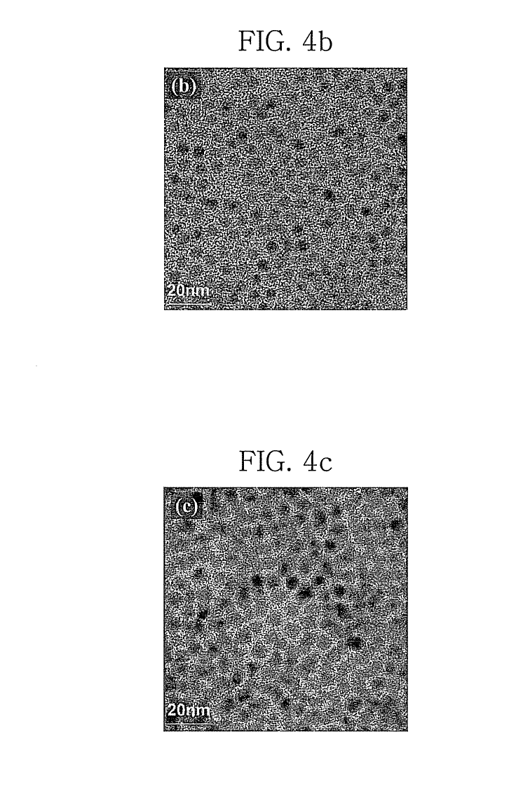

FIGS. 4a-4c show TEM images of nanocrystals obtained at each reaction steps, in which spherical particles show uniform size distribution, and heterogeneous CdS or ZnS particles are not present. FIG. 4a is a TEM image of CdS cores, FIG. 4b a TEM image of CdS cores with CdS shell, and FIG. 4c CdS core with CdS and ZnS shells. From the TEM images, the sizes of CdSe (FIG. 4a), CdSe/CdS (FIG. 4b), and CdSe/CdS/ZnS (FIG. 4c) were measured as (4.0±0.3) nm, (5.5±0.3) nm, and (6.8±0.3) nm, respectively. The size increase indicates that 2 layers of CdS and 2 layers of ZnS have formed. This result is consistent with values calculated on the basis of inductively coupled plasma atomic emission spectroscopy (herenafter “ICP-AES”) results, which are disclosed in Table 1. Reactants in Table 1 refer to mmols used of each reactant, respectively, while composition provides element ratio as measured by ICP-AES. These results illustrate that in this example, a 0.7 nm CdS layer (one monolayer of CdS is 0.35 nm) was formed on a 4.0 nm CdSe core and a 0.62 nm of ZnS layer (one monolayer of ZnS is 0.31 nm) was formed on a 5.5 nm CdSe/CdS core/shell structure.

TABLE 1

| | | Composition | | |
|---|---|---|---|---|
| Batch | Reactants | (Cd:Se:Zn:S elemental ratio) | | |
| Scale | (mmol Cd:Se:Zn:S) | CdSe | CdSe/CdS | CdSe/CdS/ZnS |
| 0.5 g | 1.6:0.4:4:5.2 | 1.5:1:0:0 | 3.5:1:0:2 | 4:1:3.5:6 |
| 1.0 g | 3.2:0.8:8:10.4 | 1.3:1:0:0 | 3.4:1:0:2.3 | 4.3:1:3.5:6.3 |
| 3.0 g | 9.6:2.4:24:31.2 | 1.4:1:0:0 | 3.4:1:0:1.9 | 4.1:1:3.7:6.3 |

### Example 2

### Synthesis of Green Fluorescent CdSe/CdS/ZnS Nanocrystals

TOA, 200 ml, oleic acid, 5.4 g, and cadmium oxide, 0.618 g, were simultaneously added to a round-bottom flask provided with a reflux condenser, and the mixture heated to 300° C. while the mixture was stirred. Separately, selenium (Se) powder was dissolved in TOP to obtain a Se-TOP complex solution with a Se concentration of about 0.5 M. To the reaction mixture, 7.5 ml of the 0.5 M Se-TOP complex solution was quickly added while the reaction mixture was stirred, and the reaction stirred for 20 seconds at a controlled temperature of 28° C.

Separately, a solution of zinc acetate was prepared by dissolving 24 mmol of zinc acetate in 8 ml of TOA. The zinc acetate solution was then added to the reaction mixture drop-wise. Subsequently, a solution of octanethiol, 20 mmol in 4 ml of TOA, was added drop-wise to the reaction mixture, and the mixture stirred for 60 minutes.

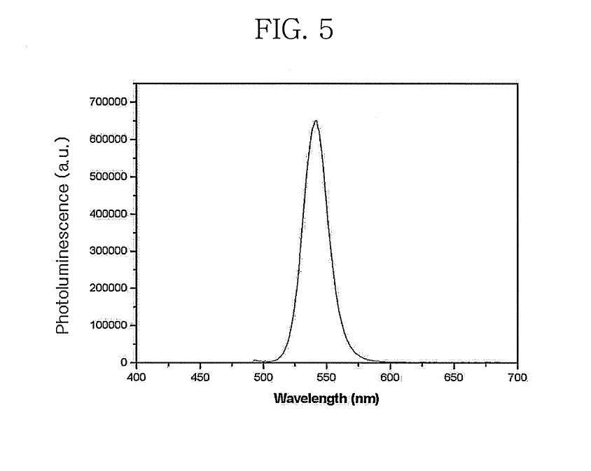

Next, the reaction mixture was cooled to room temperature as rapidly as possible. Ethanol, a non-reactive solvent, was added to the reaction mixture, and the resulting mixture centrifuged. The precipitate obtained from centrifugation was separated from the supernatant, and the precipitate dispersed in toluene to form a solution comprised of 2 g of CdSe/ZnS nanocrystals. These nanocrystals exhibited the emission wavelength of 542 nm, and had luminescence efficiency of 51% with respect to Rhodamine 6G. FIG. 5 shows a luminescence spectrum of nanocrystals prepared according to Example 2.

As is apparent from the foregoing description of the present invention, the synthesis of nanocrystal cores and the formation of shells on the cores to form a structure with one or more layers can be accomplished in a one pot process, without a core separation step, by sequentially reacting two or more kinds of precursors in one pot. As a result, high quality multi-shell nanocrystals, having diverse bandgaps and high luminescence efficiency, can be mass-produced.

### Example 3

### Preparation and Characterization of a Nanocrystal-LED

A GaN LED on sapphire substrate was prepared using semiconductor fabrication techniques. InGaN/GaN multiple quantum well LED structures were grown using the metal-organic chemical vapor deposition method. After dry etching for n-type exposure and metallization to form the p and n electrodes, a wafer was cut into the rectangles with dimensions 300 μm×300 μm and thickness of approximately 100 μm. Cup-shaped LED packages with two leads were prepared, and LED chips assembled by die attachment and wire bonding. The peak wavelength of exemplary LED emission was 390 nm, and the average radiant flux of exemplary LEDs was about 5 mW under 20 mA operation. In LED fabrication, curable-type epoxy resins, which have two components (SJ4500 A and B) from SJC Polychemical (South Korea), were mixed with 1:1 ratio. Then, 1 mL of 2 wt % [CdSe/CdS/ZnS] nanocrystal in chloroform solution was mixed with the 1 g of epoxy based resin mixture, and put in a vacuum chamber to remove chloroform and bubbles in the mixture. About 50 μL of nanocrystal-epoxy mixture was dispensed on assembled LED chips, and the assembly thermally cured at 120° C. for 2 hours. Subsequently, additional epoxy resin was applied to provide encapsulation. Finally, the 5 mm diameter (5φ) packaged LED was thermally cured at 120° C. in an oven. Optical characteristics such as radiant flux and spectra of a reference UV-LED and nanocrystal-LED were measured using a calibrated spectrophotometer with an integrating sphere (Instrument Systems) at room temperature.

It will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method, comprising:
forming a nanocrystal core from a precursor in the presence of a solvent; and
disposing a shell on the surface of the core from the solvent,
wherein forming the nanocrystal core and disposing the shell are both conducted in a single pot.

2. The method according to claim 1, wherein the forming the nanocrystal core comprises reacting a Group II, III or IV metal precursor with a Group V or VI precursor.

3. The method according to claim 1, wherein the shell comprises a reaction product of a Group II, III or IV metal precursor with a Group V or VI precursor.

4. The method according to claim 1, comprising
mixing a Group II, III or IV metal precursor with a surfactant and a solvent to obtain a metal precursor solution;
dissolving a Group V or VI precursor in a coordinating solvent to obtain a Group V or VI precursor solution; and
adding the Group V or VI precursor solution to the metal precursor solution.

5. The method according to claim 4, wherein the Group II, III or IV metal precursor solution and the Group V or VI precursor solution are obtained by dissolving the precursors in coordinating solvents.

6. The method according to claim 4, wherein the Group V or VI precursor solution are obtained by dissolving the precursors in coordinating solvents.

7. The method according to claim 4, wherein the Group II, III or IV metal precursor is dimethyl zinc, diethyl zinc, zinc acetate, zinc acetylacetonate, zinc iodide, zinc bromide, zinc chloride, zinc fluoride, zinc carbonate, zinc cyanide, zinc nitrate, zinc oxide, zinc peroxide, zinc perchlorate, zinc sulfate, dimethyl cadmium, diethyl cadmium, cadmium acetate, cadmium acetylacetonate, cadmium iodide, cadmium bromide, cadmium chloride, cadmium fluoride, cadmium carbonate, cadmium nitrate, cadmium oxide, cadmium perchlorate, cadmium phosphide, cadmium sulfate, mercury acetate, mercury iodide, mercury bromide, mercury chloride, mercury fluoride, mercury cyanide, mercury nitrate, mercury oxide, mercury perchlorate, mercury sulfate, lead acetate, lead bromide, lead chloride, lead fluoride, lead oxide, lead perchlorate, lead nitrate, lead sulfate, lead carbonate, tin acetate, tin bisacetylacetonate, tin bromide, tin chloride, tin fluoride, tin oxide, tin sulfate, germanium tetrachloride, germanium oxide, germanium ethoxide, gallium acetylacetonate, gallium chloride, gallium fluoride, gallium oxide, gallium nitrate, gallium sulfate, indium chloride, indium oxide, indium nitrate, indium sulfate, thallium acetate, thallium acetylacetonate, thallium chloride, thallium oxide, thallium ethoxide, thallium nitrate, thallium sulfate, thallium carbonate, or a combination comprising at least one of the foregoing metal precursors.

8. The method according to claim 4, wherein the Group V and VI precursor is an alkyl thiol compound comprising hexane thiol, octane thiol, decane thiol, dodecane thiol, hexadecane thiol, and mercaptopropyl silane; and alkyl phosphine compound comprising sulfur-trioctylphosphine, sulfur-tributylphosphine), sulfur-triphenylphosphine, sulfur-trioctylamine, trimethylsilyl sulfur, ammonium sulfide, sodium sulfide, selenium-trioctylphosphine, selenium-tributylphosphine, selenium-triphenylphosphine, tellurium-trioctylphosphine, tellurium-tributylphosphine, tellurium-triphenylphosphine, trimethylsilyl phosphine, triethylphosphine, tributylphosphine, trioctylphosphine, triphenylphosphine, tricyclohexylphosphine, or a combination comprising at least one of the foregoing Group V and VI precursors.

9. The method according to claim 4, wherein the solvent is C₆₋₂₂ primary alkyl amines, C₆₋₂₂ secondary alkyl amines, and C₆₋₂₂ tertiary alkyl amines, C₆₋₂₂ primary alcohols, C₆₋₂₂ secondary alcohols, C₆₋₂₂ tertiary alcohols, C₆₋₂₂ ketones and esters, C₆₋₂₂ heterocyclic compounds containing nitrogen or sulfur; C₆₋₂₂ alkanes, C₆₋₂₂ alkenes, C₆₋₂₂ alkynes, trioctylamine, trioctylphosphine, trioctylphosphine oxide, or a combination comprising at least one of the foregoing solvents.

10. The method according to claim 4, wherein the surfactant is a C₆₋₂₂ alkane and alkene having a terminal COOH group; a C₆₋₂₂ alkane and alkene having a terminal POOH group; a C₆₋₂₂ alkane and alkene having a terminal SOOH group; a C₆₋₂₂ alkane and alkene having a terminal NH₂ group, or a combination comprising at least one of the foregoing surfactants.

11. The method according to claim 4, wherein the surfactant is oleic acid, stearic acid, palmitic acid, hexyl phosphonic acid, n-octyl phosphonic acid, tetradecyl phosphonic acid, octadecyl phosphonic acid, n-octyl amine, hexadecyl amine, or a combination comprising at least one of the foregoing surfactants.

12. The method according to claim 1, wherein the forming the core and the disposing the shell are performed at a temperature of about 100° C. to about 460° C., respectively.

13. The method according to claim 1, wherein the forming of the core or the disposing the shell is conducted for about 5 seconds to about 4 hours.

14. The method according to claim 4, wherein the metal precursor has a concentration of about 0.0001 M to about 2.0 M.

15. The method according to claim 4, wherein the Group V or VI precursor has a concentration of about 0.0001 M to about 1.5 M.
